(19) United States
(12) Patent Application Publication
(10) Pub. No.: US 2021/0171269 A1
(43) Pub. Date: Jun. 10, 2021

(54) PACKAGE FOR AND METHOD OF HEATING OR COOKING LIQUID-EXUDING PRODUCTS

(71) Applicant: MAXWELL CHASE TECHNOLOGIES, LLC, Atlanta, GA (US)

(72) Inventors: Michael A. Johnston, Atlanta, GA (US); Christa Michelle Faunce, Atlanta, GA (US); Kareen Nguyen Huynh, Atlanta, GA (US)

(21) Appl. No.: 17/250,724

(22) PCT Filed: Aug. 27, 2019
(86) PCT No.: PCT/US2019/048281

§ 371 Date: Feb. 24, 2021

Related U.S. Application Data
(60) Provisional application No. 62/740,695, filed on Oct. 3, 2018.
(60) Provisional application No. 62/723,827, filed on Aug. 28, 2018.

(51) Int. Cl. B65D 81/26; B65D 81/34; A47J 36/02; A47J 36/04

(52) U.S. Cl. CPC B65D 81/265; B65D 81/3453; B65D 2581/3417; A47J 36/04; A47J 36/027

(57) ABSTRACT

A method of heating or cooking liquid-exuding product includes placing the liquid-exuding product onto a package (10). The package includes a porous material (20), an absorbent material (21) and a tray (12). The porous material is attached to or contacts at least a portion of the tray. The absorbent material (21) is located between the porous material and the tray. The method includes heating or cooking the combined liquid-exuding product and package. At least some liquid exuded from the liquid-exuding product during heating or cooking travels through the porous material (20) and contacts at least some of the absorbent material (21).

### CROSS-REFERENCE TO RELATED APPLICATIONS

The present application claims priority to U.S. Provisional Application No. 62/740,695, titled “SYSTEM, APPARATUS AND METHOD FOR HEATING AND/OR COOKING OF LIQUID-EXUDING PRODUCTS” and filed Oct. 3, 2018, and U.S. Provisional Application No. 62/723,827, titled “SYSTEM, APPARATUS AND METHOD FOR HEATING AND/OR COOKING OF LIQUID-EXUDING PRODUCTS” and filed Aug. 28, 2018, the entire disclosures of which is hereby incorporated by reference in their entireties.

### FIELD

The presently disclosed technology relates generally to heating and/or cooking liquid-exuding product. In one embodiment, the presently disclosed technology relates to a package that separates liquid-exuding product from liquid produced therefrom during heating or cooking of the liquid-exuding product. In one aspect, at least a portion of the package can absorb some of the liquid.

### BACKGROUND AND DESCRIPTION OF RELATED ART

It is known to store food in containers that include one or more reservoirs to retain fluids exuded from the stored food. U.S. Pat. Nos. 5,709,897 and 6,152,295, which are hereby incorporated by reference in their entireties, disclose two such containers. U.S. Pat. No. 6,376,034 (Brander), which is hereby incorporated by reference in its entirety, discloses useful absorbent materials.

It is also known to heat or cook food in containers designed to retain fluids exuded from the food. U.S. Pat. No. 4,873,101, which is hereby incorporated by reference, discloses one such container. Other prior art systems or containers are described at the following URLs (each of which were accessed on Aug. 27, 2018):
A. https://www.bakeryandsnacks.com/Article/2008/09/26/New-pad-for-microwave-and-oven-usage-is-world-first-says-firm
B. https://www.sirane.com/food-packaging-products/dri-fresh/dri-fresh-supreme.html
C. https://www.amazon.com/Microwave-Magic-Tray-Safety-Clean/dp/B000BAVREC
D. http://www.gamamicrowave.com/sheet7.html
E. https://jeffeats.com/2017/04/15/hormel-black-label-microwave-ready-original-bacon-walmart-supercenter-delray-beach/

### BRIEF SUMMARY

Despite the numerous benefits of the above and other prior art teachings, additional options are desired for heating or cooking liquid-exuding product. For example, prior art absorbent cotton or pulp-based pads with plastic top or bottom layer absorb some of the grease or fluid from the liquid-exuding product, but are messy and do not allow for proper heating and/or cooking in a microwave or oven, for example. The presently disclosed technology makes-up for the above and other drawbacks of the prior art.

In one aspect, the presently disclosed technology is directed to a single-use, absorbent tray with ribs to optionally microwave liquid-releasing food items. A nonwoven can be sealed or attached to at least a portion of the top of the tray to contain the absorbent and help with grease and moisture absorption. A liquid-exuding product can be placed on top of the nonwoven, and then the combination can be placed in a microwave or other heating device.

Optionally, an absorbent material can be placed in one or more reservoirs of the tray. The absorbent material can be configured to absorb grease and/or water, for example, exuded from liquid-exuding products, such as, but not limited to, bacon, sausage, or other protein.

Optionally, methods of the presently disclosed technology include providing the taste, texture (e.g., crispiness) and/or visual appearance (e.g., charred) benefits of frying proteins (e.g., bacon) via an optional microwave cooking process. Optionally, the method can be employed with a cooking apparatus other than a microwave, such as but not limited to an oven.

Optionally, a method according to the presently disclosed technology includes cooking raw proteins (e.g., bacon) in a microwave, wherein the proteins cooked via microwave mimic the taste and/or visual appearance of the same proteins cooked via frying.

Optionally, the presently disclosed technology provides and/or produces protein that looks better during and/or after heating and/or cooking of the liquid-exuding product(s) at least in part because less grease is visible.

### BRIEF DESCRIPTION OF THE DRAWINGS

The foregoing summary, as well as the following detailed description of the presently disclosed technology, will be better understood when read in conjunction with the appended drawings, wherein like numerals designate like elements throughout. For the purpose of illustrating the presently disclosed technology, various illustrative embodiments are shown in the drawings. It should be understood, however, that the presently disclosed technology is not limited to the precise arrangements and instrumentalities shown. In the drawings.

FIG. 1 is a top plan view of at least a portion of a package according to an embodiment of the presently disclosed technology;

FIG. 2 is a top perspective view of the package shown in FIG. 1;

FIG. 3 is another top perspective view of the package shown in FIG. 1;

FIG. 4 is a portion of a cross-sectional side view of the package taken along line 4-4 in FIG. 1;

FIG. 5 is yet another perspective view of the package shown in FIG. 1;

FIG. 6 is another top plan view of the package shown in FIG. 1; and

FIG. 7 is a side elevation view of the package shown in FIG. 1.

### DETAILED DESCRIPTION

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). Unless specifically set forth herein, the terms “a,” “an” and “the” are not limited to one element but instead should be read as meaning “at least one.” The terminology includes the words noted above, derivatives thereof and words of similar import.

The term “liquid-exuding product” is broadly defined herein to include any product or products (e.g., foodstuff) from which moisture or liquid (e.g., oil, grease and/or water) can (a) be emitted (such as but not limited to meats, fish, poultry, fruits, vegetables and the like), and/or (b) form on, adhere to and/or release from depending upon the particular environment or atmosphere (e.g., due to the dew point temperature). The term “liquid-exuding product” includes proteins. The term “protein” is broadly defined herein to include any of a class of nitrogenous organic compounds that include large molecules composed of one or more long chains of amino acids, which can be animal (e.g., bacon, raw meat, hamburger) or non-animal (e.g., beans or plant-based burgers) proteins.

Optionally, a package of the presently disclosed technology can be in the form of a container or tray. A porous material can be provided on, optionally attached to, at least a portion (e.g., an outer perimeter) of the tray. The porous material can include or house an absorbent, or can retain the absorbent in or more reservoirs in the tray. Alternatively, an absorbent can be omitted. Optionally, a film or cover can be placed over the liquid-exuding product to enclose the liquid-exuding product between the film/cover and the tray. The package can be used to heat and/or cook the liquid-exuding product.

In one embodiment, the package includes a polypropylene ribbed tray with no sidewalls. The package can include or house an absorbent that is capable of absorbing grease, as well as water and/or other liquids, during heating or cooking of the liquid-exuding product. A porous sheet, e.g., a nonwoven material, can be heat sealed to the tray to allow liquids to flow through, while preventing the absorbent from exiting one or more reservoirs of the tray.

In one embodiment, the presently disclosed technology is directed to a process for allowing the liquid to flow through the porous material and interact with the absorbent material to form a gel, which is too bulky, oversized or large to pass back through (e.g., upward through) the porous material.

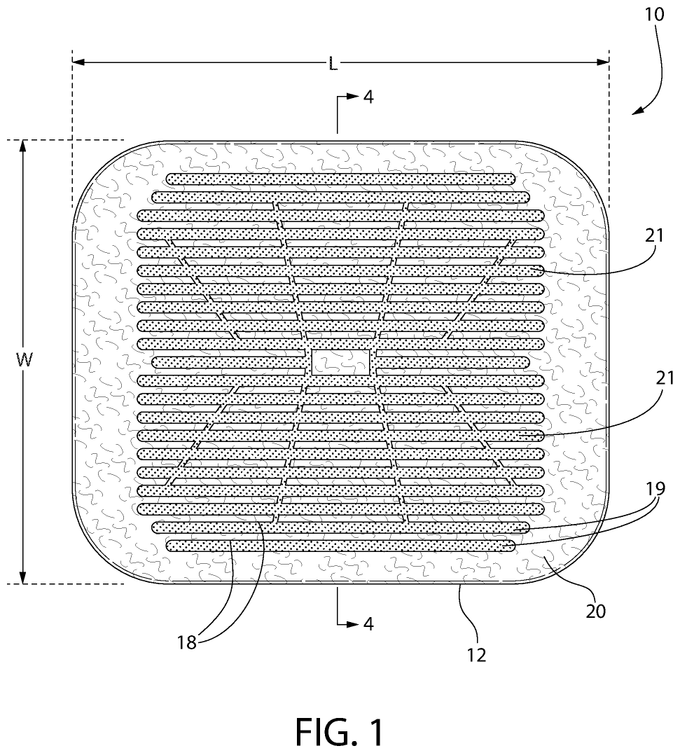

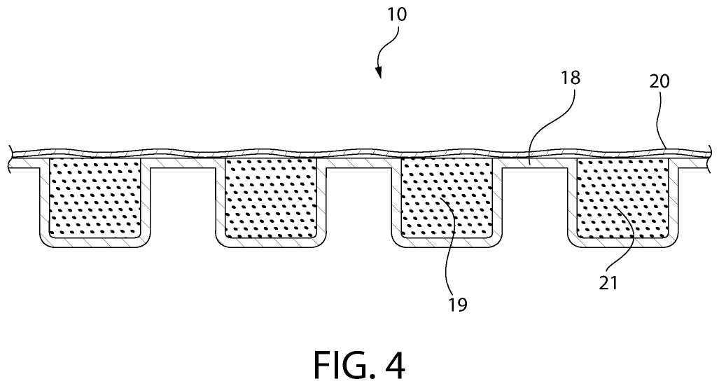

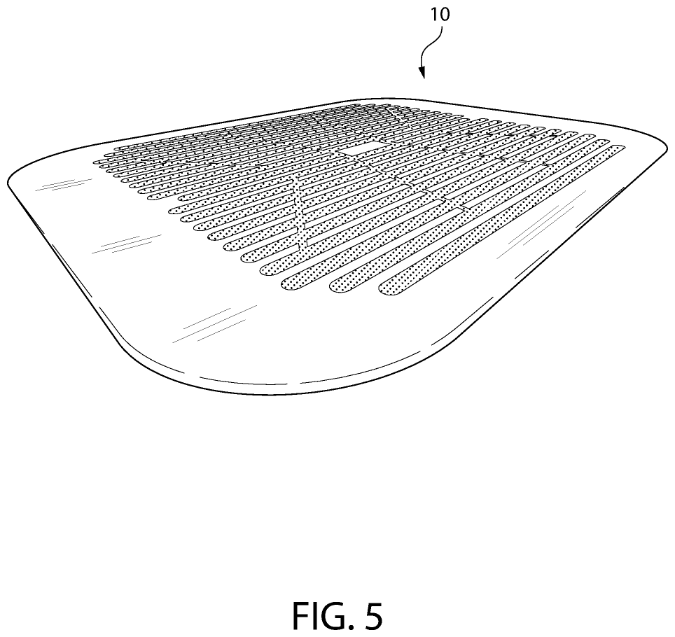

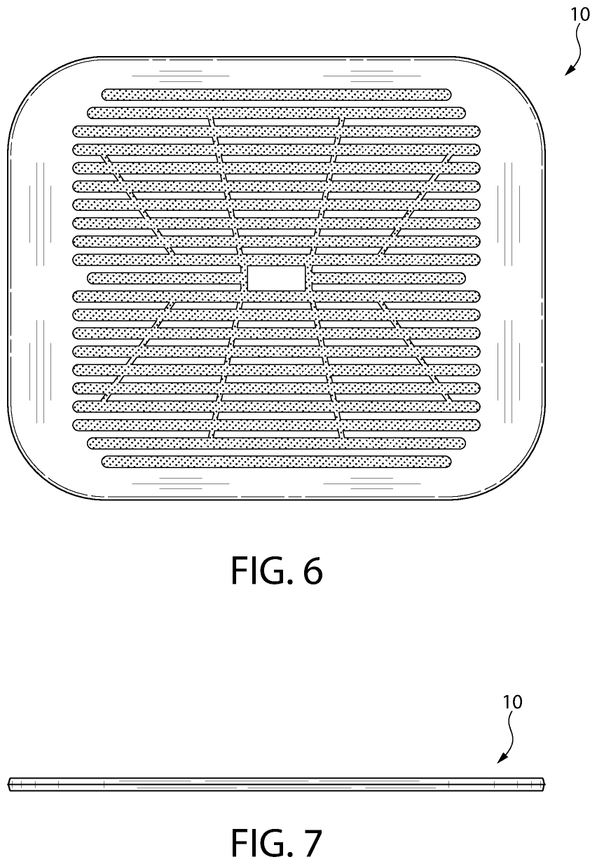

Referring now in detail to the various figures of the drawings wherein like reference numerals refer to like parts throughout, FIGS. 1-7 show a package 10 that may be used according to an aspect of the disclosed concept. Optionally, the package 10 can include a tray 12 having a top surface and an opposing bottom surface extending generally or exactly perpendicularly thereto.

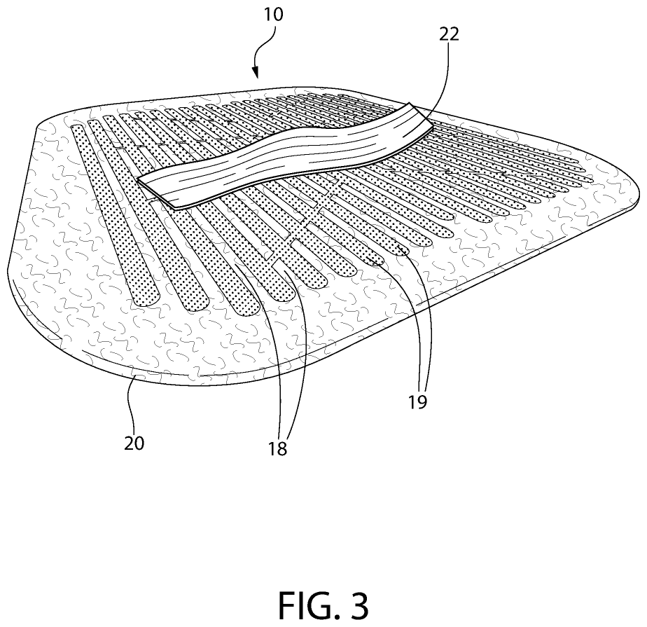

In one embodiment, the tray 12 includes two or more spaced-apart structural ribs 18. Optionally, the ribs 18 can form a plurality of spaced-apart openings that extend through the tray 12, or one or a plurality of spaced-apart reservoirs or cavities 19, such as but not limited to between adjacent ribs 18. In combination, the ribs 18 can form a support structure, such that a top surface of each of the ribs 18 can combine to form (or can be) the top surface of the tray 12 and/or a support surface or platform for liquid-exuding product (shown generally in FIG. 3 as reference number 22). Optionally, the liquid-exuding product 22 can be supported by the support surface.

The size, shape, and/or configuration of the ribs 18 can be modified depending upon the heating or cooking needs. For example, the ribs 18 can extend in parallel to one another. The ribs 18 can extend parallel or perpendicular to one or more outer edges of the tray 12, or extend at an angle thereto. Optionally, adjacent ribs 18 can be spaced-apart at equal or unequal intervals. For example, the ribs can be larger and/or more spaced-apart than as shown in FIGS. 1-3. The ribs are not limited to being straight or planar structures, as the ribs can be in the form of rectangular or square wells, for example.

Optionally, the tray 12 is formed of a rigid or semi-rigid polymer, such as polypropylene, polyethylene, polyethylene terephthalate (PET) or crystalline PET, and/or is in the form of a thermoform tray. Optionally, the tray 12 and any portion or components thereof are designed to be sufficiently inexpensive to produce so as to be disposable or recyclable after a single use. In one embodiment, rigidity of the tray 12 can make it easier for a user to insert or remove it from a microwave or other cooking apparatus (such as but not limited to an oven or toaster oven), as well as make it easier to transport the liquid-exuding foodstuff (e.g., such as from the microwave to a trash can). Optionally, the tray 12 can be sufficiently rigid such that it does not bend or buckle under the weight of the liquid-exuding product.

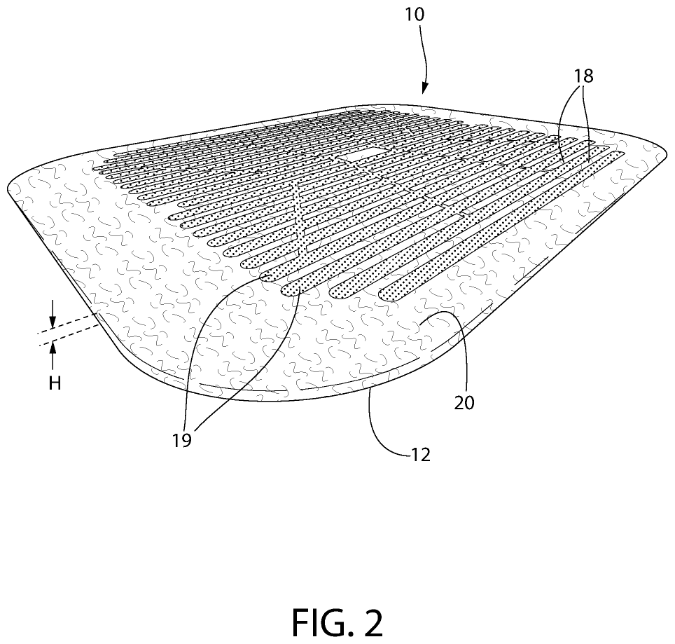

Optionally, the tray 12 can have dimensions of 8.5 to 12 inches (preferably approximately 10.5 inches) long (see “L” in FIG. 1) by 7 to 9 inches (preferably approximately 8 inches) wide (see “W” in FIG. 1) by 0.1 to 0.5 of an inch (preferably approximately 0.3 of an inch) thick or high (see “H” in FIG. 2). However, the length “L”, width “W” and height “H” of the tray 12 and/or package 10 can be smaller or greater, depending upon needs. Optionally, the ribs 18 can be spread or spaced-apart over the tray 12 and each rib 18 can be approximately 7-10 inches long, 0.1 to 0.5 of an inch wide, and 0.1 to 0.5 (preferably approximately 0.2) of an inch deep. In one embodiment, the material of the tray 12 and/or the ribs 18 can be approximately 0.1 inches thick. Of course, other dimensions are possible or even desirable depending upon the circumstances. Optionally, in any embodiment, the tray 12 is rigid or semi-rigid, i.e., it is capable of maintaining its shape under gravity. Moreover, the rigidity of the tray 12 is preferably such that it may also maintain its shape under the weight of the foodstuffs disposed on top of it.

A porous material 20 can be attached to the top surface 14 of the tray 12. The porous material 20 can be in the form of a sheet. Optionally, the porous material 20 can be in the form of a nonwoven material.

In one embodiment, the porous sheet is a nonwoven that includes or is composed of polyethylene terephthalates and polyethylene in a sheath and core configuration, thereby allowing the porous sheet 20 to be heat sealed to the tray to contain an absorbent material 21 (see FIG. 1) between the ribs, while also allowing free liquid to flow through it. Optionally, the porous sheet 20 can have a density of approximately 20 g/m², or in the range of 10-30 g/m² or in the range of 10-50 g/m². Optionally, the porous sheet 20 can have a thickness of 50 to 250 microns, optionally approximately 130 microns. In one embodiment, the porous sheet 20 can include surfactants that allow water and oil wicking on the fibers.

In one embodiment of the package, the ribs of the tray can be omitted, and the porous material can form a pouch or cavity above and/or on the top surface of the tray to contain the absorbent material.

In one embodiment, the absorbent material (e.g., contained between the ribs 18) can be code II silica or aluminum silica gel with an average particle size of (or less than) 1 mm Optionally, the absorbent material can include one or more of a gel, a mineral (e.g., salt) and a cross link (e.g., bifunctional water-soluble crosslinker for carboxyl, amine and hydroxyl functional polymers, or ethylene glycol diglycidyl ether (EGDGE)). The absorbent material, if included, can be positioned in or at a bottom of one or more of the spaces or reservoirs 19 formed by the ribs 18. Optionally, the absorbent material retains any or most liquid exuded from the liquid-exuding product. In one embodiment, the absorbent material can be a superabsorbent material, which in a dehydrated state occupies very little or low volume and creates very little or less bulk. The absorbent material can be provided within and/or below a water permeable material, such as the porous material 20.

In any embodiment, the absorbent material is formed of liquid absorbing particles, preferably larger than 100 μm to be held in between the ribs 18 and/or in the one or more reservoirs by the porous sheet. Optionally, the absorbent material includes or is comprised of silica either natural or synthetic with varying cations.

Optionally, the absorbent material can be a composition of matter (e.g., powder mixture) or a single article (e.g., sponge), for example.

Absorbent materials usable in conjunction with methods according to the disclosed concepts include food safe absorbent materials having an absorbent composition of matter suitable for use with food products. The absorbent composition of matter has an absorbency, the absorbency being defined by weight of liquid absorbed/weight of the absorbent composition of matter.

In any embodiment, the absorbent material includes a cross-linked or a non-cross-linked gel-forming polymer. Such gel-forming polymer can be water soluble or insoluble. In any embodiment, the absorbent material further includes at least one of the following: 1) at least one mineral composition, 2) at least one soluble salt having at least one trivalent cation, and/or 3) an inorganic buffer.

In an optional embodiment, the absorbent material includes at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe, the absorbent composition of matter being compatible with food products such that the absorbent composition of matter is food safe when in direct contact with the food products.

In an optional embodiment, the absorbent material includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; and (ii) at least one mineral composition having a second absorbency, the second absorbency being defined by weight of liquid absorbed/weight of the at least one mineral composition, the at least one mineral composition being food safe, the absorbency of the absorbent material exceeding the first absorbency and the second absorbency, the absorbent material being compatible with food products such that the absorbent composition of matter is food safe when in direct contact with the food products. It should, however, be understood that alternative absorbent materials such as those described above may be used in accordance with the disclosed concept.

In an optional embodiment, the absorbent material includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; and (ii) at least one soluble salt having at least one trivalent cation, the at least one soluble salt having at least one trivalent cation being food safe, the absorbency of the absorbent material exceeding the first absorbency and the second absorbency, the absorbent material being compatible with food products such that the absorbent composition of matter is food safe when in direct contact with the food products. It should, however, be understood that alternative absorbent materials such as those described above may be used in accordance with the disclosed concept.

In an optional embodiment, the absorbent material includes the following: (i) at least one non-crosslinked gel-forming water soluble polymer having a first absorbency, the first absorbency being defined by weight of liquid absorbed/weight of the at least one non-crosslinked gel forming polymer, the at least one non-crosslinked gel forming polymer being food safe; (ii) at least one mineral composition having a second absorbency, the second absorbency being defined by weight of liquid absorbed/weight of the at least one mineral composition, the at least one mineral composition being food safe; and/or (iii) at least one soluble salt having at least one trivalent cation, the at least one soluble salt having at least one trivalent cation being food safe, the absorbency of the absorbent composition of matter exceeding a sum of the first absorbency and the second absorbency, the absorbent material being compatible with food products such that the absorbent composition of matter is food safe when in direct contact with the food products. It should, however, be understood that alternative absorbent materials such as those described above may be used in accordance with the disclosed concept. Any of the embodiments of the absorbent composition of matter described above may optionally comprise an inorganic or organic buffer.

Optionally, the absorbent material contains from about 10% to 90% by weight, preferably from about 50% to about 80% by weight, and most preferably from about 70% to 75% by weight polymer. The non-crosslinked gel forming polymer can be a cellulose derivative such as carboxymethylcellulose (CMC) and salts thereof, hydroxyethylcellulose, methylcellulose, hydroxypropylmethylcellulose, gelatinized starches, gelatin, dextrose, and other similar components, and may be a mixture of the above. Certain types and grades of CMC are approved for use with food items and are preferred when the absorbent is to be so used. The preferred polymer is a CMC, most preferably sodium salt of CMC having a degree of substitution of about 0.7 to 0.9. The degree of substitution refers to the proportion of hydroxyl groups in the cellulose molecule that have their hydrogen substituted by a carboxymethyl group. The viscosity of a 1% solution of CMC at 25° C., read on a Brookfield viscometer, should be in the range of about 2500 to 12,000 mPa. The CMC used in the Examples following was obtained from Hercules, Inc. of Wilmington, Del. (under the trade name B315) or from AKZO Nobel of Stratford, Conn. (under the trade name AF3085).

Optionally, a clay ingredient of the absorbent can be of any variety of materials and is preferably attapulgite, montmorillonite (including bentonite clays such as hectorite), sericite, kaolin, diatomaceous earth, silica, and other similar materials, and mixtures thereof. Preferably, bentonite is used. Bentonite is a type of montmorillonite and is principally a colloidal hydrated aluminum silicate and contains varying quantities of iron, alkali, and alkaline earths. The preferred type of bentonite is hectorite which is mined from specific areas, principally in Nevada. Bentonite used in the Examples following was obtained from American Colloid Company of Arlington Heights, Ill. under the trade name BENTONITE AE-H.

Diatomaceous earth is formed from the fossilized remains of diatoms, which are structured somewhat like honeycomb or sponge. Diatomaceous earth absorbs fluids without swelling by accumulating the fluids in the interstices of the structure. Diatomaceous earth was obtained from the American Colloid Company.

In one embodiment, clay and diatomaceous earth are present in an amount from about 10-90% by weight, optionally about 20-30% by weight, however, some applications, such as when the absorbent material is to be used to absorb solutions having a high alkalinity, i.e., marinades for poultry, can incorporate up to about 50% diatomaceous earth. The diatomaceous earth can replace nearly all of the clay, with up to about 2% by weight remaining clay.

Optionally, a trivalent cation is provided in a soluble salt, such as derived from aluminum sulfate, potassium aluminum sulfate, and other soluble salts of metal ions such as aluminum, chromium, and the like. Optionally, the trivalent cation is present at about 1% to 20%, most preferably at about 1% to 8%.

An inorganic buffer is one such as sodium carbonate (soda ash), sodium hexametaphosphate, sodium tripolyphosphate, and other similar materials. An organic buffer in the absorbent can be citric acid, monopotassium phosphate, or buffer mixture with a set pH range. If a buffer is used, it is optionally at about 0.6%, however, beneficial results have been achieved with amounts up to about 15% by weight.

The mixture of the non-crosslinked gel forming polymer, trivalent cation, and clay forms an absorbent material which, when hydrated, has an improved gel strength over the non-crosslinked gel forming polymer alone. Further, the gel exhibits minimal syneresis, which is exudation of the liquid component of a gel.

In addition, the combined ingredients form an absorbent material which has an absorbent capacity which exceeds the total absorbent capacity of the ingredients individually. While not limited by this theory, it appears that the trivalent cation provides a cross-linking effect on the CMC once in solution, and that the clay swells to absorb and stabilize the gels. Further, as shown by Example D of Table 1 below, it appears that, in some cases at least, it is not necessary to add trivalent cation. It is thought that perhaps a sufficient amount of trivalent cation is present in the bentonite and diatomaceous earth to provide the crosslinking effect.

The gels formed by the absorbent material of the invention are glass clear, firm gels which may have applications in other areas such as for cosmetic materials. Some embodiments of the disclosed concept are set forth in Table 1. As used in Table 1, absorption is defined as the increased weight achieved in an absorbent pad structure of the type described in U.S. Pat. No. 6,376,034, following placement of such pad in a tray-type container with 0.2% saline therein in such quantities as to not limit the access of fluid to the pad for up to 72-96 hours until no further increase of weight is apparent. The net absorption is the difference between the final weight of the pad and the dry starting weight, after deducting the net absorbency of the base pad material other than the absorbent blend i.e. the fabric component. This is converted to a gram/gram number by dividing the net absorption by the total weight of absorbent blend incorporated in the pad. Such a procedure is accurate for comparative purposes when the pad structure used is the same for all the tested blends.

TABLE 1
EXAMPLES OF PREFERRED EMBODIMENTS

| | | | Absorbence-gm/gm | | | |
|---|---|---|---|---|---|---|
| | | | Individual | Expected from | | Actual/ |
| | Ingredient | weight % | Ingredient | Summation | Actual | Expected |
| A | CMC-B315 | 71.3 | 35 | 26.59 | 43.12 | 162.17% |
| | Potassium Aluminum Sulfate | 6.19 | 0 | | | |
| | Bentonite (i.e., Hectorite) | 22.5 | 7 | | | |
| B | CMC-AF3085 | 71.2 | 35 | 27.5 | 53.94 | 196.15% |
| | Potassium Aluminum Sulfate | 6.32 | 0 | | | |
| | Diatomaceous Earth | 20.2 | 32 | | | |
| | Bentonite | 2.2 | 7 | | | |
| C | CMC-AF3085 | 74.4 | 35 | 28.75 | 65.37 | 227.37% |
| | Potassium Aluminum Sulfate | 1.47 | 0 | | | |
| | Diatomaceous Earth | 21.2 | 12 | | | |
| | Bentonite | 2.35 | 7 | | | |
| | Soda Ash (sodium carbonate) | 0.58 | 0 | | | |
| D | CMC-AF3085 | 70 | 35 | 26.12 | 56.74 | 217.23% |
| | Diatomaceous Earth | 27 | 12 | | | |
| | Bentonite | 3 | 7 | | | |
| E | granulated CMC-AF3085 | 70.7 | 35 | 26.37 | 49.17 | 186.46% |
| | Potassium Aluminum Sulfate | 6.14 | 0 | | | |
| | Bentonite | 23.2 | 7 | | | |
| F | CMC-AF3085 | 70.8 | 35 | | | |
| | Potassium Aluminum Sulfate | 6.89 | 0 | 27.35 | 51.79 | 189.36% |
| | Bentonite | 2.23 | 7 | | | |
| | Diatomaceous Earth | 20.1 | 12 | | | |
| G | CMC-AF3085 | 54.0 | 35 | 24.67 | 48.97 | 198.5% |
| | Bentonite | 40.0 | 7 | | | |
| | Alginate | 5.94 | 50 | | | |
| | Calcium Chloride | 0.06 | 0 | | | |
| H | CMC-AF3085 | 75.3 | 35 | 27.98 | 62.51 | 223.4% |
| | Bentonite | 23.2 | 7 | | | |
| | Potassium Aluminum Sulfate | 1.5 | 0 | | | |
| I | CMC-AF3085 | 73.5 | 35 | 27.35 | 64.42 | 235.5% |
| | Bentonite | 23.2 | 7 | | | |
| | Potassium Aluminum Sulfate | 3.3 | 0 | | | |
| J | CMC-B315 | 31.82 | 35 | 18.46 | 32.85 | 177.9% |
| | Diatomaceous Earth | 54.96 | 12 | | | |
| | Bentonite | 10.44 | 7 | | | |
| | Potassium Aluminum Sulfate | 2.78 | 0 | | | |

It is apparent from Table 1 that a significant synergistic effect has been achieved in the absorption behavior of these blends, resulting in dramatic improvement in absorption capacity of the blends compared to the individual components. As the non-CMC ingredients are of much lower cost than CMC itself, the blends achieve major reductions in cost per unit weight of absorption.

The absorbent material is not particularly limited to any material class. However, the absorbent material needs to be food safe, possesses a desirable absorbency, and exhibits a minimum syneresis. For example, the absorbent material may include one or more of the following: tissue paper, cotton, sponge, fluff pulp, polysaccharide, polyacrylate, psillium fiber, guar gum, locust bean gum, gellan gum, alginic acid, xyloglucan, pectin, chitosan, poly(DL-lactic acid), poly(DL-lactide-co-glycolide), poly-caprolactone, polyacrylamide copolymer, ethylene maleic anhydride copolymer, cross-linked carboxymethylcellulose, polyvinyl alcohol copolymers, cross-linked polyethylene oxide, starch grafted copolymer of polyacrylonitrile, and a cross-linked or non-cross-linked gel-forming polymer.

In one embodiment, a lidding or cover film is disposed over the tray 12 to enclose the liquid-exuding product (such as, but not limited to, bacon) stored therein so as to provide an enclosed package. Optionally, the film is sealed to the tray 12. Optionally, the lidding film is transparent, which allows a user to view the quality of the liquid-exuding product heated and/or cooked on the tray 10. In one embodiment, the lidding film is a polyethylene composition, optionally a biaxially stretched polyethylene composition.

In one embodiment, the combined tray 12, porous sheet 20 and liquid-exuding product can be put into a pouch before inserting the combination into a microwave or oven.

Additional features can be utilized to inhibit or prevent growth of microbes and/or kill microbes in the package, such as those described in International Application Publication No. WO2018/089933, which is hereby incorporated by reference in its entirety.

The following exemplary embodiments further describe optional aspects of the presently disclosed technology and are part of this Detailed Description. These exemplary embodiments are set forth in a format substantially akin to claims (each set including a numerical designation followed by a letter (e.g., “A,” “B,” etc.), although they are not technically claims of the present application. The following exemplary embodiments refer to each other in dependent relationships as “embodiments” instead of “claims.”

1A. A package for heating or cooking liquid-exuding product, the package comprising:

a tray having one or more reservoirs formed therein; and

a porous material provided on, optionally attached to, a top surface of the tray,

wherein the package is configured to support liquid-exuding product on top of the porous material and above the one or more reservoirs during heating or cooking of the liquid-exuding product, the one or more reservoirs being configured to receive and retain at least some liquid exuded from the liquid-exuding product during heating or cooking thereof, the package optionally including the liquid-exuding product on top of the porous material.

2A. The package of embodiment 1A, wherein the liquid-exuding product is foodstuff.

3A. The package of embodiment 1A or 2A, wherein the foodstuff is protein.

4A. The package of embodiment 3A, wherein the protein is bacon.

5A. The package of any preceding embodiment, wherein the porous material is a sheet that covers at least the one or more reservoirs of the tray.

6A. The package of any preceding embodiment, wherein the porous material is formed of a nonwoven material.

7A. The package of any preceding embodiment, wherein the package is configured to be discarded after heating or cooking one time in a microwave.

8A. The package of any preceding embodiment, wherein absorbent material is contained in at least one of the one or more reservoirs.

9A. The package of embodiment 8A, wherein the porous material retains the absorbent material in the one or more reservoirs.

10A. The package of embodiment 8A or 9A, wherein the absorbent material absorbs at least one of oil or water molecules exuded from the liquid-exuding product during heating or cooking of the liquid-exuding product.

11A. The package of any of embodiments 8A-10A, wherein the absorbent material includes liquid-absorbing particles formed of silica.

12A. The package of any preceding embodiment, wherein the porous material includes liquid-absorbing particles.

13A. The package of embodiment 12A, wherein the particles include silica.

14A. The package of embodiment 13A, wherein the particles include synthetic silica with cations.

15A. The package of any preceding embodiment, wherein the porous material includes polyethylene terephthalates and polyethylene in a sheath and core configuration.

16A. The package of any preceding embodiment, wherein the porous material has a thickness of 50 to 250 microns, optionally approximately 130 microns.

17A. The package of any preceding embodiment, wherein the porous material includes surfactants.

18A. The package of any preceding embodiment, wherein the tray is formed of a polyolefin, optionally polypropylene or polyethylene.

19A. The package of any preceding embodiment, wherein the tray includes a plurality of spaced-apart ribs that extend parallel to one another, and wherein each of the one or more reservoirs is formed between two adjacent ribs.

20A. The package of any preceding embodiment, wherein the tray does not include a sidewall extending upwardly from the top surface around an outer periphery thereof.

21A. The package of any preceding embodiment, wherein a film is placed over the liquid-exuding product to enclose the liquid-exuding product during heating or cooking thereof.

1B. A method of heating and/or cooking liquid-exuding product, the method comprising:

providing a package comprising:
a tray having one or more reservoirs formed therein for receiving and retaining liquid exuded by liquid-exuding product; and
a porous material, optionally a nonwoven material, attached to a top surface of the tray; and

placing liquid-exuding product on the porous material;

placing a film over the liquid-exuding product;

placing the combined package, liquid-exuding product and film into a microwave; and

heating or cooking the combined package, liquid-exuding product and film in the microwave for a predetermined period of time.

2B. The method of embodiment 1B, wherein the porous material includes an absorbent therein.

3B. The method of embodiment 1B, wherein an absorbent material is retained in the one or more reservoirs by the porous material.

While the presently disclosed technology has been described in detail and with reference to specific examples thereof, it will be apparent to one skilled in the art that various changes and modifications can be made therein without departing from the spirit and scope thereof. It is understood, therefore, that the presently disclosed technology is not limited to the particular embodiments disclosed, but it is intended to cover modifications within the spirit and scope of the present presently disclosed technology as defined by the appended claims.

1. A method of heating or cooking liquid-exuding product, the method comprising:
placing liquid-exuding product onto a package, the package including a porous material, an absorbent material and a tray, the porous material being attached to at least a portion of the tray, the absorbent material being located between the porous material and the tray; and
heating or cooking the combined liquid-exuding product and package,
wherein at least some liquid exuded from the liquid-exuding product during heating or cooking travels through the porous material and contacts at least some of the absorbent material.

2. The method of claim 1, wherein the step of heating or cooking the combined liquid-exuding product and package is done in a microwave.

3. The method of claim 1, wherein the tray includes at least one reservoir formed therein.

4. The method of claim 3, wherein the at least one reservoir contains the absorbent material, the porous material being configured to confine the absorbent material in the at least one reservoir, the absorbent material being configured to absorb at least one of grease or water exuded from the liquid-exuding product.

5. The method of claim 1, wherein the at least some liquid exuded from the liquid-exuding product flows through the porous material and interacts with the absorbent material to form a gel.

6. The method of claim 5, wherein the gel is too bulky or large to pass from the at least one reservoir through the porous material.

7. The method of claim 3, wherein the at least one reservoir includes a plurality of spaced-apart reservoirs.

8. The method of claim 7, wherein each of the plurality of spaced-apart reservoirs contains the absorbent material.

9. The method of claim 7, wherein only certain, but not all, of the plurality of spaced-apart reservoirs contain the absorbent material.

10. The method of claim 7, wherein the tray includes a plurality of spaced-apart ribs, and wherein adjacent ribs are separated by one of the plurality of spaced-apart reservoirs.

11. The method of claim 10, wherein each of the plurality of spaced-apart ribs extend in parallel.

12. The method of claim 1, wherein the porous material is attached to an outer periphery of the tray.

13. The method of claim 1, wherein the porous material is heat sealed to the tray.

14. The method of claim 1, wherein the liquid-exuding product is protein.

15. The method of claim 14, wherein the protein is an animal protein.

16. The method of claim 14, wherein the protein is a non-animal protein.

17. The method of claim 1, wherein the tray is formed of any one of polypropylene, polyethylene, polyethylene terephthalate (PET) or crystalline PET.

18. (canceled)

19. (canceled)

20. The method of claim 1, wherein the porous material is in the form of a sheet, and wherein the sheet of porous material is formed of a nonwoven material.

21. The method of claim 20, wherein the sheet of porous material comprises polyethylene terephthalates and polyethylene in a sheath and core configuration.

22. The method of claim 1, wherein the absorbent material is code II silica or aluminum silica gel.

23. (canceled)

24. The method of claim 2, further comprising:
placing a lid or cover over the liquid-exuding product and the package prior to heating or cooking the liquid-exuding product in the microwave.

25. The method of claim 24, wherein the lid or cover is a transparent film that is at least partially sealed to the package prior to heating or cooking the liquid-exuding product in the microwave.

26. (canceled)

27. (canceled)

28. (canceled)

29. (canceled)

30. (canceled)

31. (canceled)

32. A package configured to absorb at least some liquid exuded from bacon during heating or cooking the bacon, the package comprising:
a tray having a length of 8.5 to 12 inches, a width of 7 to 9 inches, and a height of 0.1 to 0.5 inches, the tray including a plurality of spaced-apart ribs and a plurality of spaced-apart reservoirs between adjacent pairs of the plurality of spaced-apart ribs, the ribs extending in parallel;
absorbent material contained in each of the plurality of spaced-apart reservoirs, the absorbent material being in the form of a plurality of particles having an average particles size of or less than 1 mm; and
a sheet of porous material extending across a top surface of the tray, the sheet of porous material being attached to at least a portion of the tray, the sheet of porous material and the tray enclosing the absorbent material therebetween, the sheet of porous material being formed of a nonwoven material,
wherein the absorbent material is configured to absorb at least some liquid exuded from bacon during heating or cooking the bacon on top of the sheet in a microwave.

33. The package of claim 32, wherein the sheet of porous material is heat sealed to the tray.

34. (canceled)
